(19) United States
(12) Patent Application Publication
(10) Pub. No.: US 2009/0113253 A1
(43) Pub. Date: Apr. 30, 2009

(54) SYSTEM AND APPARATUS FOR DELIVERING MEDIA AND METHOD FOR PLAYING STREAMING MEDIA

(75) Inventors: Zhibing WANG, Shenzhen (CN); Zhefeng YAN, Shenzhen (CN); Jiying DUI, Shenzhen (CN); Haohua CHEN, Shenzhen (CN); Yaohui LI, Shenzhen (CN); Jiahao WEI, Shenzhen (CN); Chuansong XUE, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: Huawei Technologies Co., Ltd., Shenzhen (CN)

(21) Appl. No.: 12/335,798

(22) Filed: Dec. 16, 2008

Related U.S. Application Data
(63) Continuation of application No. PCT/CN2008/070082, filed on Jan. 10, 2008.

(30) Foreign Application Priority Data
Apr. 3, 2007 (CN) 200710089600.X

(51) Int. Cl. G06F 15/16; G06F 11/07

(52) U.S. Cl. 714/48; 709/227; 709/231; 714/E11.024

(57) ABSTRACT

A media delivery system includes a media manager (MM) a central server that supports peer to peer (P2P) technology (CS-P), a request routing system that supports P2P technology (RRS-P), and an edge server that supports P2P technology (ES-P) and multiple P2P clients. A method for playing streaming media based on the above media delivery system includes: the MM publishes a live channel notification to the CS-P, RRS-P, and ES-P; the CS-P obtains streaming data packets from a live source and parses and slices the packets to generate slice data; the ES-P obtains the slice data from the CS-P and/or other ES-Ps that are able to provide slice data and caches the slice data; and the P2P client obtains the slice data from the ES-P or other P2P clients and delivers the data, or the data is played by a local player after an assembly operation by the P2P client. With the P2P technology, the present invention improves the prior media delivery network and realizes the playing of streaming media to a large number of clients.

### CROSS-REFERENCE TO RELATED APPLICATIONS

This application is a continuation of International Patent Application No. PCT/CN2008/070082, filed Jan. 10, 2008, which claims priority to Chinese Patent Application No. 200710089600.X, filed Apr. 3, 2007, both of which are hereby incorporated by reference in their entirety.

### FIELD OF THE INVENTION

The present invention relates to communication technologies, and, in particular, to a media delivery system and a method for playing streaming media.

### BACKGROUND OF THE INVENTION

A content/media delivery network (CDN/MDN) has emerged in a prior art, delivering website contents from a source node to a network edge node closest to a user so that the user obtains desired contents from proximity, thus, increasing the response speed when a user visits a website. For multimedia contents, such as video on demand (VoD) and live video, because video transport is in real time and large volume, delivering video contents to an edge node closest to a user assures better quality of playing for the user and significantly reduces impacts on the backbone network.

The structure of a CDN/MDN in the prior art is shown in FIG. 1. The CDN/MDN includes: (1) A media manager (MM), adapted to be a center for content delivery and scheduling; support publication and cancellation of on-demand, live, time-shifted, and advertisement programs; and support intelligent delivery, intelligent deletion, pull, and exchange of program contents.

(2) An end user portal (EU-Portal), functions of which mainly include: program presentation: displaying program contents to users via portal pages; login authentication: providing an interface for user login and logout and authenticating the identity of a user at the first login; program search: providing a content retrieval function to support search of program contents by category; ranking: supporting ranking of hot programs and ranking of programs by category; program recommendation: supporting a content/service provider (CP/SP) in recommending and promoting programs; and self service: logging, by a user, in to the portal to add, delete, query, or modify personal attributes, or query programs the user orders.

(3) A content management system (CMS), functions of which mainly include: content management: providing management functions including content publishing and cancellation, entry of source data, content query, and attribute modification; and CP/SP management: providing management functions including user definition and user deletion.

(4) A service management system (SMS), functions of which mainly include: user management: defining, deleting and querying users and modifying user attributes; program management: creating, deleting and querying programs and modifying program attributes; product management: defining, canceling and querying products and service packages, and setting discounts; statistic analysis: making statistic analysis based on users, time segments, CPs/SPs or programs; rights management: defining system roles, defining and assigning rights, and querying and modifying role rights; system management: configuring, querying and modifying system parameters; and authentication and authorization: authenticating the identity of a user and the content usage and preventing theft links to contents.

(5) A request routing system (RRS), functions of which mainly include: ingress of user requests and scheduling center of the MDN; load balance based scheduling policies within an edge server (ES) group; resource assignment and resource-based scheduling for SPs; and static scheduling of users.

(6) A central server (CS), adapted to provide original data sources for ESs, but normally not provide direct services for a user.

(7) An edge server (ES), adapted to provide streaming services for end users directly; provide streaming proxy; support streaming services like VoD, live video, and time-shifted video; and monitor online and offline states of users and provide the usage mediator (UM) with evidence of user consumption.

(8) An operation management center (OMC), mainly adapted to provide service configuration, device management, and alarm management functions.

(9) A usage mediator (UM), adapted to screen different external authentication and accounting interfaces of the MDN and provide a uniform internal authentication and accounting interface of the MDN.

In the CDM/MDN shown in FIG. 1, after a user request for video contents is redirected by the RRS to an edge autonomous system (AS), the ES in the edge AS streams unicast video to the user directly. Because streaming data is provided by the ES and the bandwidth on the ES is definite, the number of servable users is limited. To satisfy user needs, it is necessary that the capability of an edge node increases linearly with the growth of users. However, with the foregoing conventional CDN/MDN structure, investment in an edge node is huge. Because service requests of users are indefinite, even though the system capability of the edge node is increased, it is impossible to fully meet all abrupt rises of user requests. As a result, when concurrent user requests in an area exceed the maximum capacity of the network, the network can only deny the service.

At present, many pure peer to peer (P2P) steaming software systems are operating on the Internet. A common feature of these systems is that they are able to set up mutual help relations between clients via a scheduling module in the network. Streaming servers in the network provide only a few streams and clients (peer nodes) deliver streaming data to each other by means of the above mutual help relations so that a large number of clients can view streaming programs simultaneously. The scheduling module does not record topology relations of the network and the nodes help each other in a best effort way. The inventor finds that the conventional P2P streaming software system does not consider geographic issues, which may result in a large volume of traffic across the backbone network. Moreover, because the scheduling module does not record the topology relations of nodes and does not provide uniform resource scheduling, data delivery basically relies on the mutual help of nodes. Therefore, channel zapping takes a long time and programs of large bit streams cannot be supported. In addition, the unsteady programs and the best effort help mode may also result in unstable playing of programs.

### SUMMARY OF THE INVENTION

Embodiments of the invention provide a media delivery system, which adopts peer to peer (P2P) technology to improve the prior media delivery network and realizes playing of streaming media to a large number of clients.

A media delivery system provided in an embodiment of the invention includes a media manager (MM). The system further includes a central server that supports P2P technology (CS-P), a request routing system that supports P2P technology (RRS-P), an edge server that supports P2P technology (ES-P), and multiple P2P clients. The MM is adapted to publish a live channel notification to the CS-P, RRS-P, and ES-P. The CS-P is adapted to receive the live channel published by the MM, obtain streaming data packets from a corresponding live source and parse and slice the packets to generate slice data; and receive a data request initiated by the ES-P and send slice data to the ES-P. The RRS-P is adapted to receive a request for joining the live channel initiated by a P2P client, return to the P2P client information of an ES-P and/or other P2P client nodes that are able to provide slice data in a home area of the P2P client. The ES-P is adapted to obtain slice data of the live channel from the CS-P and/or other ES-Ps that are able to provide slice data and cache the slice data locally; and receive a live channel data request initiated by a P2P client and send slice data of the live channel to the requesting P2P client. The P2P client is adapted to obtain slice data of the live channel from the ES-P and/or other P2P clients returned by the RRS-P, which are able to provide slice data and let a local player play the data after an assembly operation; and cache the obtained slice data, receive a request from another P2P client and send the slice data to the other P2P client in P2P mode.

A central server that supports P2P technology (CS-P) provided in an embodiment of the invention includes a first P2P connection manager. The server further includes: a first channel manager, adapted to obtain basic information of a live channel published by a MM and add/delete a live channel via a first interface with the MM; a packet parser, adapted to obtain streaming data packets from a live source encoder via a second interface with a live source and parse the packets. A P2P slicer is adapted to slice obtained streaming data packets.

A request routing system that supports P2P technology (RRS-P) provided in an embodiment of the invention includes a second P2P connection manager. The system further includes: an ES/CS manager, adapted to detect faults of connected ES-Ps and CS-Ps and record topology relations between ES-Ps and CS-Ps. A load balancer is adapted to calculate loads of ES-Ps and select a lightly loaded ES-P; a user scheduler, adapted to receive a request for joining a live channel from a P2P client via an eighth interface with the P2P client, schedule the P2P client to the home area of the P2P client, invoke the load balancer to select a lightly loaded ES-P, and schedule the P2P client to the ES-P selected from the home area; or receive a data request initiated by an ES-P and return address information of a CS-P or other ES-P nodes that are able to provide slice data via a seventh interface with the ES-P.

An edge server that supports P2P technology (ES-P) provided in an embodiment of the invention includes a third P2P connection manager. The server further includes: a third channel manager, adapted to obtain and record basic information of a live channel and add/delete a live channel via a tenth interface with a MM; a second load reporter, adapted to collect and measure load information of ES-Ps and report the load information to a RRS-P via a seventh interface with the RRS-P. A second media cache manager is adapted to cache obtained slice data packets, receive a data request initiated by a P2P client, and send slice data to the P2P client.

A P2P client provided in an embodiment of the invention includes a fourth P2P connection manager. The client further includes a decoder, adapted to obtain slice data from an ES-P or other P2P clients, decode the slice data, restore original data packets and send the packets to a media player. A media player is adapted to play a program, according to the received streaming data.

A method for playing streaming media, applicable to the media delivery system provided in an embodiment of the invention, includes: publishing, by the MM, a live channel notification to the CS-P, RRS-P, and ES-P; by the ES-P, obtaining slice data from the CS-P and/or other ES-Ps that are able to provide slice data and caching the slice data, where the slice data is generated by the CS-P after the CS-P obtains streaming data packets from a live source and parses and slices the packets; by the ES-P, receiving a data request from a P2P client and sending cached slice data to the P2P client; and by the P2P client, obtaining the slice data from the ES-P or other P2P clients and delivering the data, or playing by a local player after an assembly operation.

With the P2P technology, embodiments of the invention improve the content/media delivery network in the prior art. The new CS-P, ES-P and RRS-P, together with P2P clients, fully use the capabilities of the P2P client so that the system has better scalability to meet the concurrent play requests of a large number of clients and that the investment in edge servers is also reduced.

The media delivery system provided in an embodiment of the invention is also able to converge with the prior content/media delivery network so that the implementation cost is low.

### BRIEF DESCRIPTION OF THE DRAWINGS

FIG. 1 shows the structure of a conventional CDN/MDN;

FIG. 2 shows the structure of a media delivery system, according to an embodiment of the invention;

FIG. 3 shows the interface protocols between components of a media delivery system, according to an embodiment of the invention;

FIG. 4 shows the structure of a CS-P provided in an embodiment of the invention;

FIG. 5 shows the structure of a RRS-P provided in an embodiment of the invention;

FIG. 6 shows the structure of an ES-P provided in an embodiment of the invention;

FIG. 7 shows the structure of a P2P client provided in an embodiment of the invention;

FIG. 8 shows a signaling procedure where contents of a P2P live channel are delivered, according to an embodiment of the invention;

FIG. 9 shows a signaling procedure where an ES-P obtains a live stream in P2P mode, according to an embodiment of the invention;

FIG. 10 shows a signaling procedure where content delivery of a P2P live channel is cancelled, according to an embodiment of the invention;

FIG. 11 shows a registration signaling procedure of a P2P client, according to an embodiment of the invention;

FIG. 12 shows a signaling procedure where a user chooses a live channel program, according to an embodiment of the invention;

FIG. 13 shows a signaling procedure where an idle P2P client requests to be a helper node, according to an embodiment of the invention; and

FIG. 14 shows a signaling procedure for detecting and reassigning helper nodes.

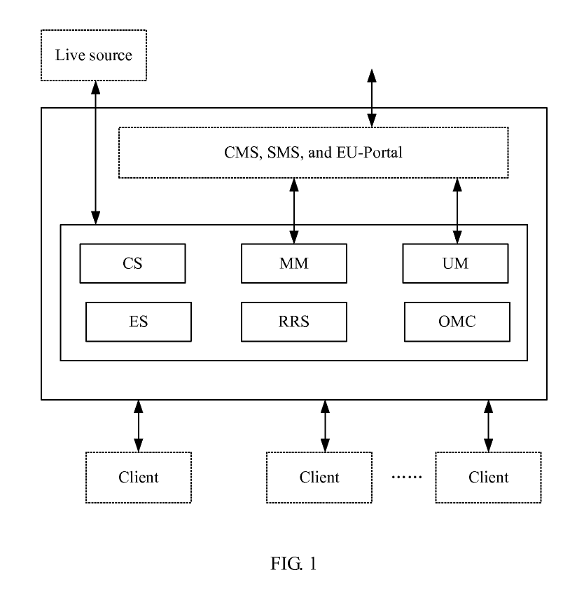

### DETAILED DESCRIPTION OF THE INVENTION

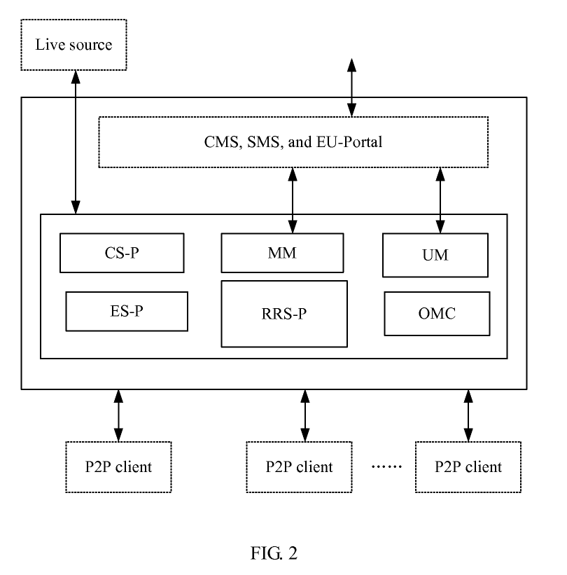

The structure of a media delivery system provided in an embodiment of the invention is shown in FIG. 2. The system includes a content management system (CMS), a service management system (SMS), an operation management center (OMC), a media manager (MM), an end user portal (EU-Portal), and a usage mediator (UM), which are the same as those in a prior media delivery network (MDN). The system further includes a central server that supports P2P technology (CS-P), a request routing system that supports P2P technology (RRS-P), an edge server that supports P2P technology (ES-P), and a number of P2P clients.

The CS-P, ES-P, and RRS-P provide additional P2P functions, respectively, on the basis of the CS, ES, and RRS in a prior MDN.

In the system, the CS-P, RRS-P, and ES-P are in 1+1+N configuration, which means there is a pair of CS-Ps, a pair of RRS-Ps (two-node cluster hot backup), and multiple ES-Ps.

The RRS-P is the scheduling server of the system, which schedules P2P live requests, creates, and maintains topology relationships, provides a P2P client with a peer list, and implements load balance based scheduling policies for ES-P groups.

The CS-P obtains live streams from live sources and slices live streams, according to a P2P slicing rule. Then, the CS-P packs sliced data packets to a few more packets than original by using the redundant coding technology and sends the sliced data streams to the ES-P. Take a 1 Mbps bit stream for example. The traffic per second is sliced to 20 parts based on time and 22 packets are generated using the Reed-Solomon algorithm. This means the entire bit stream is sliced to 22 sub-streams, which are sent to the ES-P.

The ES-P provides data streams for P2P clients in push and pull mode or provides bandwidth compensation ability for some P2P clients.

A P2P client supports the P2P technology, adapted to present and play P2P programs. The P2P client is a trigger factor of P2P topology maintenance and serves other client nodes, while viewing programs under organization of the scheduling server (RRS-P). Considering that the limited uplink bandwidth for an individual client in the case of asymmetric digital subscriber line (ADSL) access does not fully meet the need of mutual help, the system incorporates a helper node (detailed implementation to be described hereinafter). This means some clients do not actually view programs but stay online to receive some data, replicate the data, and then deliver the data to other multiple clients in need of the data. For example, a client only receives an above mentioned sub-stream (50 kbps) and then delivers the sub-stream to the other four client nodes.

The media delivery system provided in an embodiment of the invention includes the following devices on the network side: operation support devices (SMS, SMS, and EU-Portal), live source device (encoder), MM, UM, RRS-P, CS-P, and ES-P. From the networking perspective, the SMS, CMS, EU-Portal, encoder, MM, UM, RRS-P, and CS-P are deployed in a central node, while the ES-P is deployed in an edge node as an edge server. When there are a large number of users in one edge node, multiple ES-Ps can be deployed in the node to serve the users.

The central node performs channel management, SP management, service presentation, content coding, content delivery, user scheduling, load balance, authentication and authorization, and topology maintenance for the P2P live service. The edge node completes data service of the P2P live service and performs data compensation for a P2P node.

From the aspect of device hardware, the SMS, CMS, and EU-Portal may operate on respective universal PC servers or share one advanced telecom computing architecture (ATCA) frame with the MM, OMC, UM, and CS-P. To save costs, the MM and OMC may share one ATCA board. The edge node adopts the universal PC server as the hardware server, one ES-P corresponding to one PC server.

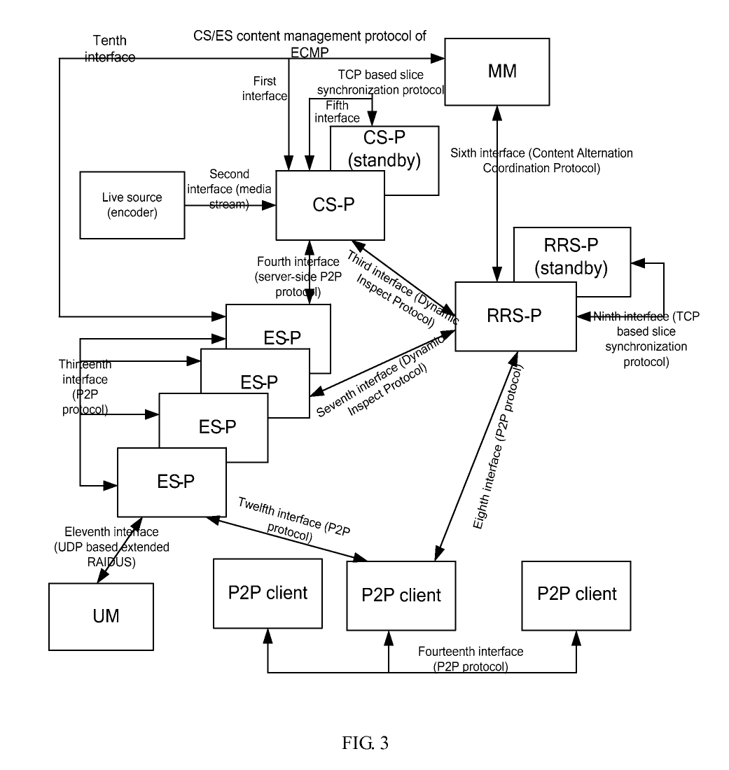

FIG. 3 shows the interface protocols between components of a media delivery system according to an embodiment of the invention, including:

(1) A First Interface Between CS-P And MM

The first interface adopts the ES/CS Management Protocol (ECMP), which is a protocol between CS/ES and MM over the User Datagram Protocol (UDP).

The first interface carries interactive signaling between CS-P and MM, based on UDP. When the CS-P obtains a P2P live channel from the live source encoder, which is equal to the effect that a P2P live channel is published to the CS-P, the MM needs to be notified that the P2P live channel is published to the CS-P. Upon reception of the message, the MM needs to add a record about the delivery of contents to the CS-P in the database. When one P2P live channel needs to be deleted, the MM notifies the CS-P to delete the local P2P live channel information according to the related record in the content delivery table.

(2) A Second Interface Between CS-P And Live Source Encoder

The CS-P obtains streaming data packets after a live program is encoded via the second interface.

The second interface is related to the type of encoder, specifically:

When a Windows media video (WMV) live encoder is adopted, the output mode is usually WMV over HTTP; when a H.264 live encoder is adopted, the output mode is usually H.264 over TS over UDP. In WMV over HTTP mode, the CS-P acts as a HTTP streaming client to request data from the encoder; in H.264 over TS over UDP mode, the CS-P is able to receive a live data stream directly if it knows the output port of the encoder.

(3) A Third Interface Between CS-P And RRS-P

The third interface is based on the Dynamic Inspect Protocol (DIP). The CS-P sends its load information to the RRS-P via the third interface for processing.

(4) A Fourth Interface Between CS-P And ES-P

The fourth interface between CS-P and ES-P is a server-side P2P interface. The CS-P and ES-P exchange signaling and data via the fourth interface, specifically:

A P2P live channel may be published to the ES-P via the MM directly or the ES-P may be triggered by a user request to obtain P2P live data from the CS-P.

(5) A Fifth Interface Between Active CS-P And Standby CS-P

In the media delivery system provided in the embodiment of the invention, the CS-P works in dual-node cluster hot backup mode. One CS-P acts as an active CS-P and the other CS-P acts as a standby CS-P. The fifth interface adopts the P2P slice synchronization interface protocol based on the Transmission Control Protocol (TCP) to keep data synchronization between the active CS-P and the standby CS-P.

(6) A Sixth Interface Between RRS-P And MM

The sixth interface adopts the Content Alternation Coordination Protocol (CACP) to carry interactive signaling between RRS-P and MM over UDP, specifically as follows.

When the MM initiates publishing, cancellation, or update of a P2P live channel, the active and standby RRS-Ps are notified via the sixth interface. In addition, when a RRS-P is faulty, the information is refreshed in the faulty RRS-P in real time. In this way, channel information is kept consistent between the active RRS-P and the standby RRS-P at any time.

(7) A Seventh Interface Between RRS-P And ES-P

The seventh interface between RRS-P and ES-P adopts the DIP protocol to regularly synchronize the load information and resource assignment information of the ES-P. Therefore, the RRS-P stores the latest load and resource assignment information of the ES-P. In this way, the RRS-P is able to schedule ES-Ps in the autonomous system (AS) in load balancing mode. Meanwhile, the RRS-P can also detect the bandwidth consumption information of the ES-Ps in real time in the system so as to manage the lease of bandwidth. Because the ES-P is able to report load and resource assignment information simultaneously to the active and standby RRS-Ps, the load and resource assignment information in the active and standby RRS-Ps is kept consistent.

(8) An Eighth Interface Between RRS-P And P2P Client

The eighth interface between RRS-P and P2P client is a P2P signaling interface based on the P2P protocol. When a user requests to join or leave a channel, or requests to close a P2P client, or requests a new peer node, the request is sent to the RRS-P. The RRS-P adjusts the topology according to the requested operation. When the user selects a channel to view, the user is added to the topology tree of a certain channel in a certain AS. When the user leaves the channel or closes the P2P client, the RRS-P reschedules the user to a certain topology tree of the corresponding AS and then the RRS-P can adjust the topology.

(9) A Ninth Interface Between Active RRS-P And Standby RRS-P

The ninth interface adopts a P2P topology synchronization interface protocol based on TCP to realize the data synchronization between the active RRS-P and the standby RRS-P.

When the standby RRS-P is recovered from a fault, the active RRS-P synchronizes the topology information in entirety to the standby RRS-P via the interface; when the topology information is consistent between both RRS-Ps, the topology adjustment due to a user's joining or leaving a channel is synchronized to the standby RRS-P as an increment value. With the topology synchronization interface, topology information is completely synchronized between the active and standby RRS-Ps so that users can be served uninterruptedly.

(10) A Tenth Interface Between ES-P And MM

The ES-P and MM exchange signaling for live channel publishing and deletion via the tenth interface, specifically:

The interface between ES-P and MM is based on the ECMP protocol. When the ES-P obtains a P2P live channel from the CS-P, which is equal to the effect that a P2P live channel is published to the ES-P, the MM needs to be notified that the P2P live channel is published to the ES-P. Upon reception of the message, the MM needs to add a record about the delivery of contents to the ES-P in the database. When one P2P live channel needs to be deleted, the MM notifies the ES-P to delete the local P2P live channel information, according to the related record in the content delivery table.

(11) An Eleventh Interface Between ES-P And UM

The interface between ES-P and MM adopts the UDP based Remote Authentication Dial in User Service (RAIDUS) protocol to check the legality of programs consumed by a user, report accounting start/end and charging duration information, and measure and report P2P client contributed uplink bandwidth, ES-P compensated bandwidth, and peer node compensated bandwidth.

(12) A Twelfth Interface Between ES-P And P2P Client

The twelfth interface between ES-P and P2P client adopts the P2P protocol to implement quick caching of a start data stream, compensation of lost slices, caching of P2P slices, and exchange of streaming session description information. Via the interface, the P2P client also reports statistic information, including the uplink bandwidth it contributes, compensated bandwidth obtained from the ES-P, bandwidth provided for it by other nodes, signaling traffic, and playing delay.

(13) A Thirteenth Interface Between ES-Ps

When a P2P live channel already exists in a certain ES-P of an AS, other ES-Ps in the AS obtain data from the ES-P via the thirteenth interface in P2P mode, instead of obtaining data from the CS-P.

(14) A Fourteenth Interface Between P2P Clients

P2P clients deliver data to each other via the fourteenth interface in P2P mode.

The above describes interfaces and protocols between components of the media delivery system provided in the embodiment of the invention in detail. With the above description, the functions of each component and the collaborations between components are clear.

The following describes the internal structures of the CS-P, RRS-P, ES-P, and P2P client provided in embodiments of the invention.

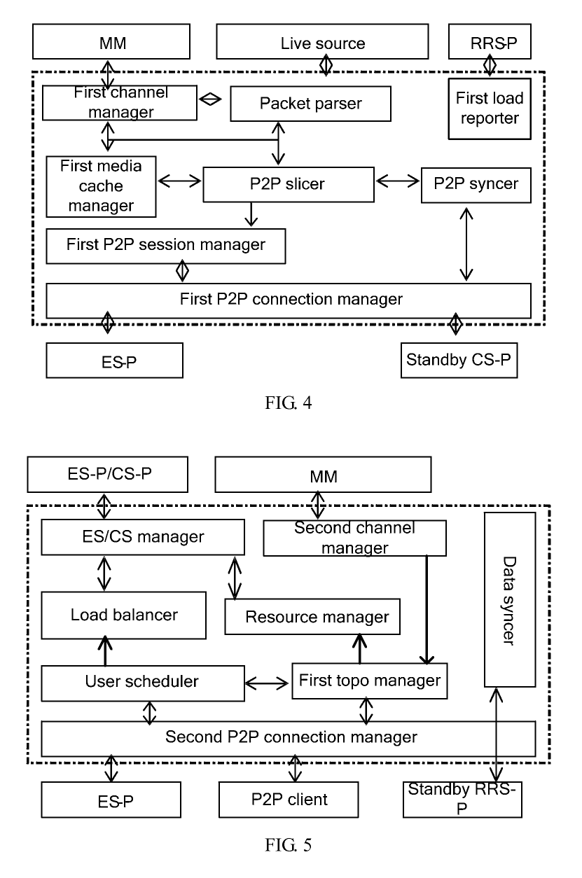

FIG. 4 shows the structure of a CS-P provided in an embodiment of the invention, including the following.

(1) A first channel manager, adapted to record basic information of a live channel published by the MM via the first interface and add/delete live channels;

(2) A packet parser, adapted to obtain streaming data packets from a live source encoder via the second interface, parse the packets and analyze slice data synchronization points between the active CS-P and the standby CS-P, including: a transport stream parser (TS parser), adapted to parse H.264 over TS over UDP packets and analyze data synchronization points between active and standby CS-Ps; a HTTP client, adapted to set up WMV over HTTP streaming connections, parse packets, and analyze data synchronization points between active and standby CS-Ps;

(3) A first load reporter, adapted to collect and measure load information of CS-Ps and report the load information via the third interface;

(4) A first media cache manager, adapted to manage the caching of streaming data packets;

(5) A P2P slicer, adapted to slice obtained streaming data packets;

(6) A P2P syncer, adapted to synchronize slice information and data synchronization points of streaming data packets to the standby CS-P;

(7) A P2P session manager, adapted to maintain and manage connected users; and

(8) A first P2P connection manager, adapted to manage external interfaces of the CS-P, and set up, maintain, and remove data and signaling channel.

FIG. 5 shows the structure of a RRS-P provided in an embodiment of the invention, including the following.

(1) An ES/CS manager, adapted to detect faults of the connected ES-P and CS-P and record topology relationships between ES-P and CS-P;

(2) A load balancer, adapted to calculate loads of ES-Ps and select an ES-P with a lighter load;

(3) A user scheduler, adapted to receive a request for joining a live channel from a P2P client via the eighth interface, schedule the P2P client to the home area of the client, and invoke the load balancer to select the lightly loaded ES-P, and schedule the P2P client to the ES-P selected from the home autonomous system; also adapted to receive data requests initiated by the ES-P via the seventh interface with the ES-P and return address information of the CS-P or other ES-P nodes that can provide slice data;

(4) A first topo manager, adapted to maintain topology information between P2P clients and topology information between ES-Ps in the AS, according to the scheduling result of the user scheduler, and provide services for the P2P clients and ES-Ps;

(5) A resource manager, adapted to support resource lease mode, record operator occupied resources, according to the topology information stored in the first topo manager, and check whether resources occupied by an operator exceed the upper limit;

(6) A second channel manager, adapted to obtain and record basic information of a live channel via the sixth interface, add/delete live channels, and send the processing result to the first topo manager;

(7) A data syncer, adapted to communicate with the standby RRS-P via the ninth interface to implement synchronous information update between the active RRS-P and the standby RRS-P; and

(8) A second P2P connection manager, adapted to manage external interfaces of the RRS-P.

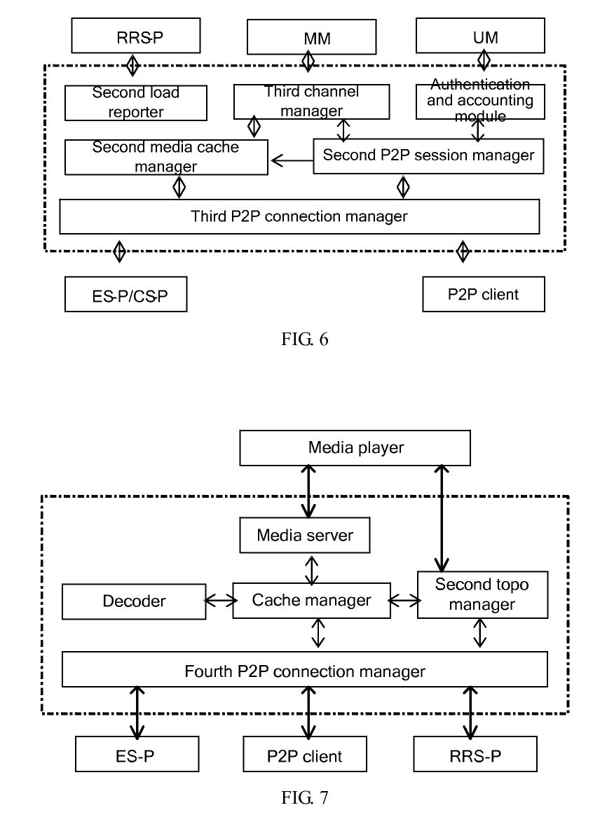

FIG. 6 shows the structure of an ES-P provided in an embodiment of the invention, including the following.

(1) A second load reporter, adapted to collect and measure load information of ES-Ps and report the load information to the RRS-P via the seventh interface;

(2) A third channel manager, adapted to obtain and record basic information of a live channel via the tenth interface and add/delete live channels;

(3) An authentication and accounting module (A&A), adapted to authenticate the user identity of a connected P2P client, perform charging for live channel programs consumed by the user, and report the information to the UM;

(4) A second media cache manager, adapted to cache obtained slice data packets, receive a data request initiated by a P2P client, and send slice data to the P2P client;

(5) A second P2P session manager, adapted to maintain and manage connected users; and

(6) A third P2P connection manager, adapted to manage external interfaces of the ES-P, and set up, maintain and remove data and signaling channels.

FIG. 7 shows the structure of a P2P client provided in an embodiment of the invention, including the following.

(1) A fourth P2P connection manager, adapted to manage external interfaces of the P2P client, and set up, maintain, and remove data and signaling connections.

Specifically, the fourth P2P connection manager is a bridge for interactions between the P2P client and the outside. It sends and receives all topology signaling information and media data of the ES-P, RRS-P, and P2P client. It directly sets up, maintains, and removes data and signaling channels. It also sends network address translation (NAT) traverse messages. The fourth P2P connection manager also manages mapping information of addresses and identifiers of the ES-P, RRS-P, and P2P client; it provides the most basic data transport service for the second top( ) manager and cache manager by means of a message queue and the callback function registration mechanism. The goal of design is to support a large number of concurrent connections data transport and screen details of the lower layer network transport so that the cache manager and the second top( ) manager only care about which node they are communicating with, without knowing how data is transferred to the other end.

(2) A decoder, adapted to decode the obtained slice data, restore original data packets and send the data packets to the cache manager.

Specifically, because media data is on the delivering side, N source data blocks are encoded to generate m (m>0) redundant data blocks by means of forward error correction (FEC) to improve the error tolerance capability of the system against packet loss and transport exceptions. The m redundant data blocks and the N source data blocks together constitute a transport group (TG) that contains N+m data packets. Relative positions of the data blocks in the TG are identified by numbering such as {0, 1, 2, . . . N+m−1}. Because of the unreliable best effort service of a packet switched network, it is possible to lose some data packets in the TG during the transport process. The receiving end determines a lost data packet and its position in the TG, according to the numbering. Due to redundancy, any N data packets in one TG may be used to reconstruct N source data packets. If the number of lost data packets is smaller than or equal to m, after the receiving end receives any N data packets of one TG, the receiving end may determine the relative positions of the lost packets, according to the numbering information, and perform FEC decoding to restore N original data packets.

(3) A cache manager, adapted to cache the decoded data packets and send the packets to a media server.

Specifically, a buffer area of a proper size is set up, via which the cache manager provides stable uninterrupted media data streams for the media server, including initial quick caching from the ES-P, checking media stream integrity, supplying streams for the media server, actively obtaining lost data from the ES-P, restoring based on redundancy, checking sub-stream exceptions, and notifying the second topo manager of sub-stream exceptions.

(4) A second topo manager, adapted to monitor and adjust P2P connection status between itself and other network nodes; specifically, including communicative interactions with the P2P client when joining the system.

The P2P client needs to maintain connections with the RRS-P, ES-P, and other P2P clients and process topology, when the P2P client exits the system or detects that another P2P client connected to it exits the system or becomes unavailable. If the P2P client itself becomes a helper node, the P2P client also needs to monitor and adjust connections of it. When the P2P client occupies too many resources of the ES-P, the P2P client attempts to obtain sub-streams from other P2P clients in P2P mode and release resources of the ES-P.

(5) A media server, adapted to send streaming media data to a media player, which means processing connection requests of the media player and sending obtained streaming information to the media player to supply streams to the media player via HTTP.

(6) A media player, adapted to play a program, according to the received streaming data. It may be a common media player, such as Microsoft Windows Media Player.

The following describes how the media delivery system provided in an embodiment of the invention is applied to play streaming media with reference to the accompanying drawings.

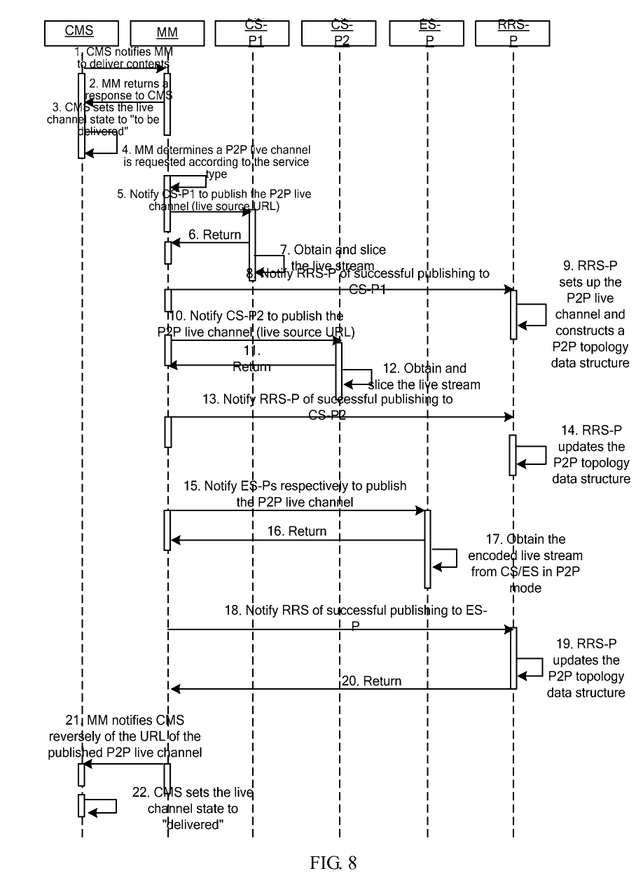

FIG. 8 shows a signaling procedure where contents of a P2P live channel are delivered, according to an embodiment of the invention. The procedure includes:

1. An operator logs in to the CMS, notifying the MM to deliver contents;

2. The MM returns a response to the CMS;

3. The CMS sets the live channel state to “to be delivered”;

4. The MM determines a P2P live channel is requested, according to the service type, and selects a device of the corresponding type;

5. The MM notifies the CS-P1 (active CS-P) to publish the P2P live channel, the notification message carrying address information of the live source, such as a uniform resource locator (URL) of the live source;

6. The CS-P1 returns the delivery result to the MM;

7. The CS-P1 obtains and slices the live stream;

8. The MM notifies the RRS-P that publishing to the CS-P1 is successful, and this step may be executed in parallel with Step 7;

9. The RRS-P sets up a P2P live channel and constructs the P2P topology data structure of the channel;

10. The MM notifies the CS-P2 (standby CS-P) to publish the P2P live channel, the notification message carrying the ULR of the live source;

11. The CS-P2 returns the delivery result to the MM;

12. The CS-P2 obtains and slices the live stream;

13. The MM notifies the RRS-P that publishing to the CS-P2 is successful, and this step may be executed in parallel with Step 12;

14. The RRS-P updates the P2P topology data;

15. The delivery of CS-P2 is successful. The MM notifies the ES-Ps, respectively, to publish the P2P live channel;

16. The ES-Ps return respective publishing results to the MM;

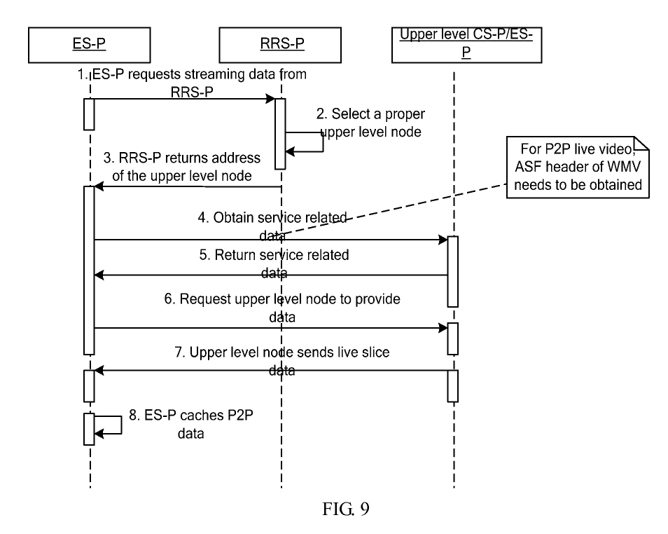

17. The ES-Ps obtain the encoded live stream from the CS/ES (upper level node) in P2P mode (detailed steps are given in the procedure in FIG. 9, where an ES-P obtains a live stream in P2P mode);

18. The ES-Ps notify the RRS-P of successful publishing, and this step may be executed in parallel with Step 17;

19. The RRS-P updates the P2P topology data structure;

20. The RRS returns the result to the MM;

21. The MM reversely notifies the CMS of the URL of the published P2P live channel; and

22. The CMS sets the live channel state to “delivered.”

With the procedure shown in FIG. 8, a P2P live channel is published.

FIG. 9 shows a signaling procedure where an ES-P obtains a live stream in P2P mode, according to an embodiment of the invention. The procedure includes:

1. The ES-P sends a data request to the RRS-P, requesting streaming data;

2. The RRS-P selects a CS-P or other ES-P that is playing the program as the upper level node of the new participant, according to the load state and proximity relationship;

3. The RRS-P returns the address information of the upper level node;

4. The ES-P requests information related to the program, such as data packet header information of a media stream in the WMV format, from the upper level node;

5. The upper level node returns service related information;

6. The ES-P sends a data request to the upper level node, requesting streaming media data corresponding to the program;

7. The upper level node sends streaming media data to the ES-P; and

8. The ES-P caches the data locally and delivers the data to the P2P client.

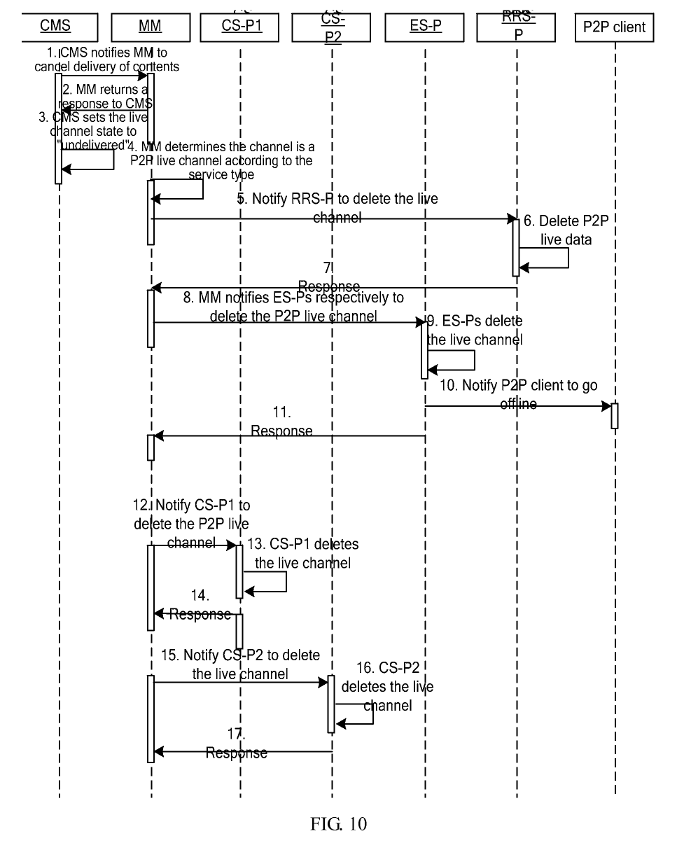

The media delivery system provided in an embodiment of the invention can also cancel the delivery of a P2P live channel, the specific signaling procedure of which is shown in FIG. 10, including:

1. An operator logs in to the CMS, specifies a channel and notifies the MM to cancel the delivery of contents;

2. The MM returns a response to the CMS;

3. The CMS sets the live channel state to “undelivered”;

4. The MM determines the channel is a P2P live channel, according to the service type;

5. The MM notifies the RRS-P to delete the live channel;

6. The RRS receives the notification from the MM and deletes data of the P2P live channel;

7. After successful deletion of the live channel, the RRS notifies the MM;

8. The MM notifies the ES-Ps, respectively, to delete the P2P live channel;

9. The ES-Ps delete the live channel;

10. The ES-Ps notify P2P clients to go offline;

11. All ES-Ps return respective deletion results to the MM;

12. The MM notifies the CS-P1 (active CS-P) to delete the P2P live channel;

13. The CS-P1 deletes the live channel;

14. The CS-P1 returns the deletion result to the MM;

15. The MM notifies the CS-P2 (standby CS-P) to delete the P2P live channel;

16. The CS-P2 deletes the live channel; and

17. The CS-P2 returns the deletion result to the MM.

FIGS. 8, 9, and 10 disclose specific signaling procedures where a live channel is published, where an ES-P obtains streaming data, and where a live channel is cancelled. The following details how a P2P client logs in to the media delivery system and selects a live channel to view.

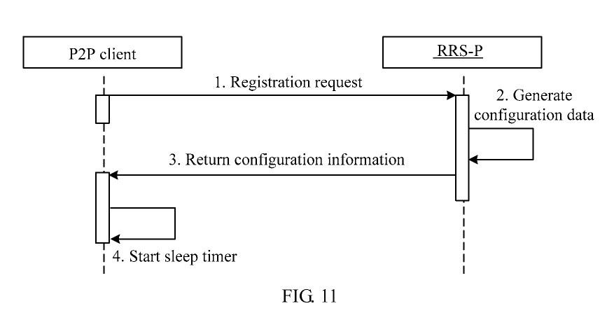

FIG. 11 shows the registration signaling procedure of a P2P client, according to an embodiment of the invention. The procedure includes:

1. The P2P client sends a registration request message to the RRS-P;

2. The RRS-P assigns a unique identifier to the client and a home client manager (the client manager is located in an ES-P and, therefore, the address of the ES-P needs to be returned); the RRS-P generates statistic items to be reported and the report time interval, which forms configuration information, according to the channel information;

3. The RRS-P returns the configuration information; and

4. The P2P client starts a sleep timer and if the client is always idle before the timer expires, the client transits to the helper state automatically. To fully use the capabilities of the P2P client, the P2P client has three states in the embodiment of the invention, namely:

(1) Idle: The P2P client enters the idle state upon startup and starts the sleep timer; if the user demands a program, the client transits to the enjoying state and stops the sleep timer; if the sleep timer expires, the client transits to the helper state;

(2) Enjoy: The user is viewing a program and when the user stops viewing the program, the client transits to the helper state; and

(3) Helper: The user is online to provide upload bandwidth and the client transits to the enjoying state when the user demands a program; the client transits to the idle state when receiving a sleep instruction sent by the RRS-P.

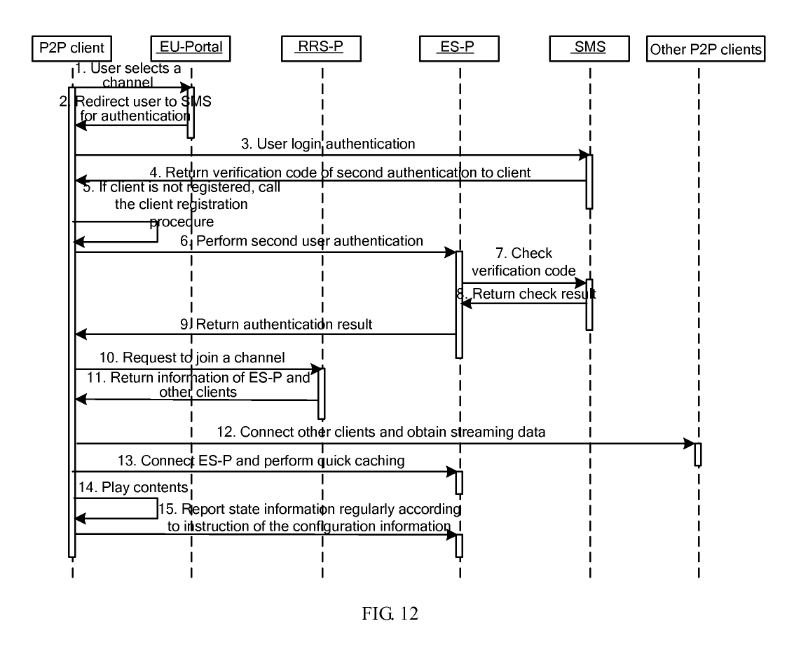

When the P2P client registers with the system, the user can select a desired live channel program to enjoy. The specific signaling procedure where a user selects a live channel program is shown in FIG. 12. The procedure includes:

1. The P2P client logs in to the portal and selects a desired channel to view;

2. If the user is not authenticated, the portal redirects the user to the SMS to authenticate the user identity; otherwise, the procedure goes to Step 5 directly;

3. The user goes to the SMS for login authentication;

4. After the SMS authenticates the user successfully, the SMS generates a verification code for a second authentication and returns the verification code to the P2P client;

5. If the P2P client is not registered, the client registration procedure shown in FIG. 11 is executed;

6. With the verification code returned in Step 4, the user is authenticated for a second time by the home client manager in the ES-P, for the purpose of preventing theft links;

7. The ES-P sends the verification code to the SMS for check;

8. The SMS returns the verification result;

9. The ES-P decides whether to allow the user to view the channel, according to the verification result;

10. After the second authentication is successful, the P2P client sends a request to the RRS-P, requesting to view a certain live channel;

11. The RRS-P assigns a group of ES-Ps to provide quick caching for the client in the home AS of the P2P client as well as a number of client nodes that are viewing the program and a number of helper nodes, according to the principle of load balance and the principle of proximity; preferably, the selected helper nodes are in the same area as the P2P client and correspond to the live channel selected by the user;

12. The P2P client initiates connection requests to the other clients returned by the RRS-P to obtain data. The connected clients keep the signaling and data connections that are based on the P2P protocol to transport control signaling and streaming data, respectively;

13. The P2P client that initiates the demand request selects a proper ES-P as its provider of compensated streams, according to the data currently owned by the other connected P2P clients, and requests the ES-P to provide data of the earlier period of time (configurable according to network conditions and performance requirements), and the ES-P caches the data quickly (quicker than the rate of playing, configurable according to network conditions and performance requirements); when the P2P client that initiates the demand request is able to obtain data from the other P2P clients, the P2P client removes the connection with the ES-P; a singling channel based on the P2P protocol is always kept between the P2P client that initiates the demand request and the ES-P, so that the P2P client can get help of the ES-P, when the P2P client cannot obtain data from the other P2P clients;

14. The P2P client that initiates the demand request caches sliced streaming data from the ES-P and the other P2P clients, assembles the sliced data, and then places the data in the player for playing; and

15. The P2P client that initiates the demand request reports state information regularly to the ES-P, according to the instruction of the configuration information obtained in the registration procedure.

With the procedure shown in FIG. 12, a user can demand a live channel program to view via a P2P client.

After the P2P client logs in to the media delivery system, it is possible that the P2P client does not demand a live channel program. In this case, to fully utilize the capabilities of the P2P client, a timer is set in the P2P client in the embodiment of the invention to implement state transition of the P2P client. When the P2P client becomes a helper node (the state of the P2P client changes to helper), the P2P client obtains media data stream and caches the media data stream locally, so as to deliver the data to other P2P clients that request the streaming data.

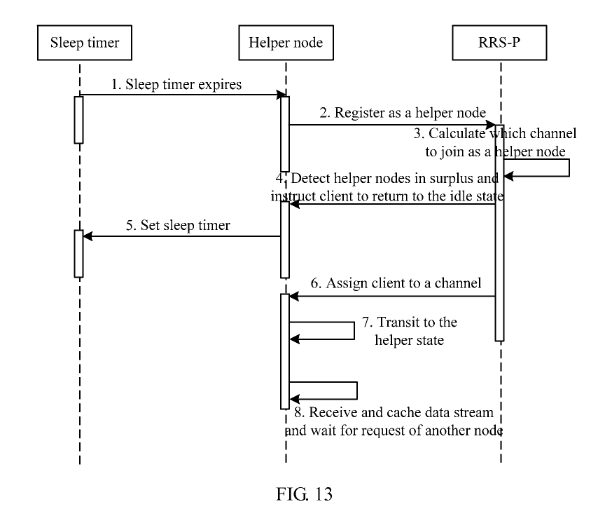

FIG. 13 shows a signaling procedure, where an idle P2P client applies to be a helper node. The procedure includes:

1. Before the sleep timer expires, the P2P client is in the idle state;

2. When the sleep timer expires, the P2P client registers with the RRS-P as a helper node;

3. The RRS-P performs calculations, according to bit streams of the channels and the ratio between current viewers and helper nodes, and assigns helper nodes to a channel in a balanced way; for example, a specific algorithm is as follows:

if the program bit rate is V, the mean contribution rate per helper node is vh, the mean contribution rate per node in the enjoying state is ve, and the current numbers of helper nodes and enjoying nodes in the channel are, respectively, h and e, then in theory, when h/e=(V−ve)/vh, the helper nodes and enjoying nodes can satisfy view requirements through mutual help; in practice, a factor p which is a little larger than 1, for example 1.1-1.2), is multiplied on the right side of the equation, and then channel with the smallest h/e value is selected as the channel to join;

4. If the channel with the smallest h/e satisfies h/e>=(V−ve)/vh, which means there are already too many helper nodes in the system, the RRS-P instructs the P2P client that currently requests to be a helper node to return to the idle state;

5. A sleep timer is set in the P2P client and when the sleep timer expires, the above procedure is executed again;

6. If the channel with the smallest h/e does not satisfy h/e>=(V−ve)/vh, the RRS-P instructs the client to join the selected channel with the smallest h/e, records client information and sets the state of the client to helper;

7. The P2P client transits from the idle state to the helper state and becomes a helper node; and

8. The P2P client joins the specified channel as a helper node to obtain and cache data streams and waits for requests of other nodes;

The procedure where a P2P client joins a channel as a helper node is the same as the procedure where a common node joins the channel. The difference is that the P2P client only obtains part of the data, for example, a 50 kbps sub-stream as described earlier. Which sub-stream to transport may be selected randomly by the client or specified in Step 3 by the RRS-P randomly or according to a certain algorithm (such as average assignment).

The ratio between helper nodes and enjoying nodes in each channel is not permanent. When the number of enjoying nodes decreases, fewer helper nodes are required. Therefore, there should be a mechanism which reassigns redundant helper nodes to other channels.

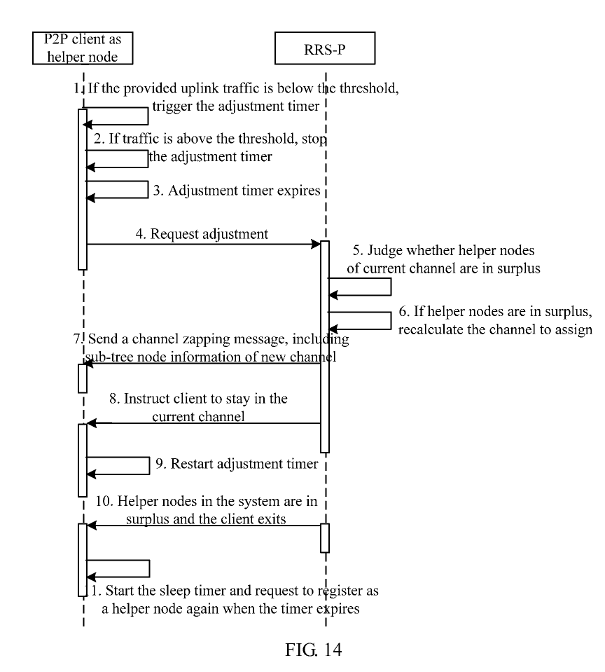

FIG. 14 shows a signaling procedure for detecting and reassigning helper nodes. The procedure includes:

1. If service requirements in need of helper nodes drop to a certain extent, for example, when the uplink traffic or the number of connected users is smaller than a preset threshold, an adjustment timer is started, with a system preset timer duration, such as 20 seconds or 30 seconds;

2. If, after the timer is started, service requirements in need of helper nodes exceed the preset threshold, the adjustment timer is stopped;

3. When the adjustment timer expires, the helper node adjustment procedure is started;

4. A helper node sends an adjustment request to the RRS-P;

5. The RRS-P checks whether helper nodes in the channel where the helper node resides are in surplus, that is, whether h/e>p(V−ve)/vh;

6. If helper nodes are in surplus, a channel with the smallest h/e is reselected and the procedure goes to Step 7; otherwise, the procedure goes to Step 8; if all channels satisfy h/e>p(V−ve)/vh, the procedure goes to Step 10;

7. The RRS-P sends a channel zapping message, instructing the helper node to exit the current channel and join a new channel; the adjustment process is over;

8. The RRS-P instructs the helper node to stay in the current channel;

9. The helper node restarts the adjustment timer;

10. There are too many helper nodes in the entire network and the RRS-P instructs the helper node to exit and return to the idle state; and

11. The helper node returns to the idle state and restarts the sleep timer; when the sleep timer expires, the node sends a new request for becoming a helper node.

To sum up, a method for playing streaming media according to an embodiment of the invention includes:

The MM publishes a live channel notification to the CS-P and ES-P;

The CS-P obtains streaming data packets from the live source and parses and slices the data packets to generate slice data;

In P2P mode, the ES-P obtains and caches slice data from the CS-P and/or other ES-Ps that can provide slice data; and

The P2P client obtains slice data from the ES-P or other P2P clients in P2P mode and requests a local player to play the media.

In embodiments of the invention, the P2P technology is adopted to improve the CDN/MDN in the prior art. By adding the CS-P, ES-P, and RRS-P with the P2P client, the system is able to meet the concurrent play requests of a large number of clients and effectively reduce investments in edge servers. Moreover, the media delivery system can converge with the prior CDN/MDN and, therefore, the implementation cost is low.

It is apparent that those skilled in the art can make various modifications and variations to the invention without departing from the spirit and scope of the invention. The present invention is intended to cover these modifications and variations provided that they fall in the scope of protection defined by the following claims or their equivalents.

What is claimed is:

1. A media delivery system, comprising a media manager (MM), a central server that supports peer-to-peer (P2P) technology (CS-P), a request routing system that supports P2P technology (RRS-P), and an edge server that supports P2P technology (ES-P), wherein:
the MM is adapted to publish a live channel notification to the CS-P, RRS-P, and ES-P;
the CS-P is adapted to receive the live channel published by the MM, obtain streaming data packets from a corresponding live source and parse and slice the packets to generate slice data, and receive a data request initiated by the ES-P and send the slice data to the ES-P;
the RRS-P is adapted to receive a request for joining the live channel initiated by a P2P client, return to the P2P client at least one of following information:
information of an ES-P in a home area of the P2P client and information of other P2P client nodes that are able to provide slice data; and
the ES-P is adapted to obtain slice data of the live channel wherein the slice data is from at least one of the following servers: the CS-P and other ES-Ps that are able to provide slice data; cache the slice data locally; and receive a live channel data request initiated by a P2P client and send slice data of the live channel to the requesting P2P client.

2. The system of claim 1, wherein a first interface exists between the CS-P and the MM; the first interface carries signaling exchanged between the CS-P and the MM;
a second interface exists between the CS-P and a live source encoder; wherein the second interface is related to a type of the encoder and the CS-P obtains streaming data packets, after a live program is encoded via the second interface;
a third interface exists between the CS-P and the RRS-P; the CS-P detects load information dynamically and reports the load information to the RRS-P via the third interface; and
a fourth interface exists between the CS-P and the ES-P; and the CS-P and the ES-P signaling and data exchange via the fourth interface.

3. The system of claim 1, wherein the CS-P acts as an active CS-P and the system further comprises at least one standby CS-P; and
a fifth interface exists between the active CS-P and the standby CS-P; the fifth interface adopts a P2P slice synchronization interface protocol to implement data synchronization between the active CS-P and the standby CS-P.

4. The system of claim 1, wherein a sixth interface exists between the RRS-P and the MM; the sixth interface carries signaling exchanged between the RRS-P and the MM;
a seventh interface exists between the RRS-P and the ES-P; the ES-P synchronizes load information and resource information of the ES-P to the RRS-P to store; the seventh interface also carries signaling and data exchanged between the RRS-P and the ES-P; and
an eighth interface exists between the RRS-P and the P2P client; the RRS-P and the P2P client exchange data via the eighth interface.

5. The system of claim 4, wherein the RRS-P acts as an active RRS-P and the system further comprises at least one standby RRS-P; and
a ninth interface exists between the active RRS-P and the standby RRS-P; the ninth interface adopts a P2P topology synchronization interface protocol to implement data synchronization between the active RRS-P and the standby RRS-P.

6. The system of claim 1, wherein a tenth interface exists between the ES-P and the MM; the ES-P and the MM exchange signaling for publishing and deleting a live channel via the tenth interface;
an eleventh interface exists between the ES-P and a usage mediator (UM); the eleventh interface adopts an extended Remote Authentication Dial in User Service (RAIDUS) protocol; the ES-P reports charging information of live channel programs consumed by a user and contributed uplink bandwidth and compensated bandwidth information of a P2P client; and
a twelfth interface exists between the ES-P and the P2P client; the ES-P and the P2P client exchange streaming session description information, slice data, bandwidth information, signaling traffic, and playing delay information via the twelfth interface; and
a thirteenth interface exists between ES-Ps for mutual data delivery.

7. A central server that supports peer-to-peer (P2P) technology (CS-P), comprising a first P2P connection manager,
a first channel manager, adapted to obtain basic information of a live channel published by a media manager (MM) and both add and delete a live channel via a first interface with the MM;
a packet parser, adapted to obtain streaming data packets from a live source encoder via a second interface with the live source and parse the packets; and
a P2P slicer, adapted to slice the obtained streaming data packets.

8. The CS-P of claim 7, further comprising:
a first media cache manager, adapted to manage caching of the streaming data packets;
a P2P session manager, adapted to maintain and manage connected users;
a P2P syncer, adapted to synchronize slice information and data synchronization points of the streaming data packets to a standby CS-P; and
a first load reporter, adapted to collect and measure load information of the CS-P and report the load information to a request routing system that supports P2P technology (RRS-P) via a third interface with the RRS-P.

9. A request routing system that supports peer-to-peer (P2P) technology (RRS-P), comprising a second P2P connection manager:
an server manager, adapted to detect faults of connected edge servers that support P2P technology (ES-Ps) and central servers that support P2P technology (CS-Ps) and record topology relations between the ES-Ps and CS-Ps;
a load balancer, adapted to calculate loads of the ES-Ps and select a lightly loaded ES-P; and
a user scheduler, adapted to receive a request for joining a live channel from a P2P client via an eighth interface with the P2P client, schedule the P2P client to a home area of the P2P client, invoke the load balancer to select a lightly loaded ES-P, and schedule the P2P client to the ES-P selected from the home area; receive a data request initiated by an ES-P and return at least one of the following address information: information of the CS-P and information of other ES-P nodes that are able to provide slice data via a seventh interface with the ES-P.

10. The RRS-P of claim 9, further comprising:
a second channel manager, adapted to obtain and record basic information of a live channel via a sixth interface with a media manager (MM), both add and delete a live channel, and send a processing result to a first topology manager;
the first topology manager, adapted to maintain topology information between P2P clients and topology information between ES-Ps according to the scheduling result of the user scheduler;
a resource manager, adapted to support resource lease, record resources occupied by a channel according to the topology information stored in the first topology manager, and check whether resources occupied by a channel exceed a set upper limit; and
a data syncer, adapted to communicate with a standby RRS-P via a ninth interface to implement synchronous information update between the active RRS-P and the standby RRS-P.

11. An edge server that supports peer to peer (P2P) technology (ES-P), comprising a third P2P connection manager, and a third channel manager, adapted to obtain and record basic information of a live channel, and both add and delete a live channel via a tenth interface with a media manager (MM);
a second load reporter, adapted to collect and measure load information and report the load information to a request routing system that supports P2P technology (RRS-P) via a seventh interface; and
a second media cache manager, adapted to cache obtained slice data packets, receive a data request initiated by a P2P client, and send slice data to the P2P client.

12. The ES-P of claim 11, further comprising:
an authentication and charging module, adapted to authenticate user identity of a connected P2P client, perform charging for live channel programs consumed by the user, and report charging information; and
a second P2P session manager, adapted to maintain and manage connected users.

13. A peer-to-peer (P2P) client, comprising a fourth P2P connection manager and further comprising:
a decoder, adapted to obtain slice data from an edge server that supports P2P technology (ES-P) or other P2P clients, decode the slice data, restore original data packets, and send the data packets to a media player; and
the media player, adapted to play a program, according to the received data packets.

14. The P2P client of claim 13, further comprising:
a cache manager, adapted to cache decoded data packets and send the packets to a media server;
the media server, adapted to send streaming data to the media player; and
a second topology manager, adapted to monitor and adjust P2P connection status between itself and other network nodes.

15. A method for delivering streaming media, applicable to a media delivery system which comprises a media manager (MM) and further comprises a central server that supports peer to peer (P2P) technology (CS-P), a request routing system that supports P2P technology (RRS-P), and an edge server that supports P2P technology (ES-P), comprising:
publishing, by the MM, a live channel notification to the CS-P, RRS-P, and ES-P;
by the ES-P, obtaining slice data from at least one of following servers: the CS-P and other ES-Ps that are able to provide slice data and caching the slice data, where the slice data is generated by the CS-P after the CS-P obtains streaming data packets from a live source and parses and slices the packets;
by the ES-P, receiving a data request from a P2P client and sending cached slice data to the P2P client.

16. The method of claim 15, wherein the step of publishing a live channel notification to the CS-P, RRS-P, and ES-P comprises:
notifying, by a content management system (CMS) in the system, the MM to deliver contents; and
by the MM, determining a P2P live channel is requested, notifying the CS-P to publish the live channel and carrying address information of a live source; notifying the RRS-P to construct a P2P topology data structure after receiving a delivery success message returned by the CS-P; notifying ES-Ps to publish the P2P live channel and notifying the RRS-P to update the P2P topology data structure after receiving a delivery success message from each ES-P.

17. The method of claim 15, wherein the step of obtaining slice data from the CS-P and/or other ES-Ps that are able to provide slice data comprises:
initiating, by the ES-P, a data request to the RRS-P;
by the RRS-P, selecting and returning at least one of the following address information: address of the CS-P address of other ES-P nodes that are able to provide slice data and returning addresses of the nodes;
initiating, by the ES-P, data requests to corresponding nodes according to the returned node addresses; and
sending, by the corresponding nodes, the slice data to the ES-P.

18. The method of claim 15, further comprising:
receiving, by the RRS-P, a register request from a P2P client to be a helper node; and
assigning, by the RRS-P, the helper node in a live channel.

19. The method of claim 15, wherein the RRS-P stores information of corresponding helper nodes of each live channel; when receiving a request for joining a live channel initiated by a P2P client, the RRS-P selects information of a corresponding helper node of the live channel in a home area of the P2P client, and returns helper node information to the P2P client.

20. The method of claim 19, wherein, when an uplink traffic volume provided by the helper node or number of connected user is below a first preset threshold,
by the RRS-P, judging whether number of helper nodes of the live channel where the helper node resides exceeds a second preset threshold, and if so, assigning the helper node to another live channel and returning channel zapping information; the helper node acting as a corresponding helper node of the other channel; and
if the number of helper nodes of the live channel where the helper node resides does not exceed the second preset threshold, instructing the helper node to act as a helper node of the channel where the helper node resides.

21. The method of claim 20, wherein, when the RRS-P judges that the number of helper nodes of every live channel exceeds a corresponding threshold, the RRS-P determines that helper nodes of an entire network are in surplus, and instructs the helper node to act as a common P2P client.

22. The method of claim 15, further comprising:
publishing, by the MM, a live channel deletion notification, respectively, to the RRS-P, ES-P, and CS-P; and processing, by the RRS-P, ES-P, and CS-P, respectively, deletion of the live channel.

23. A method for playing streaming media, comprising:
by a P2P client, obtaining slice data from an edge server that supports P2P technology (ES-P) or other P2P clients, wherein the slice data is generated by a central server that supports peer-to-peer (P2P) technology (CS-P) after the CS-P obtains streaming data packets from a live source and parses and slices the packets; and
by the P2P client, delivering the data, or playing by a local player after an assembly operation.

24. The method of claim 23, wherein the ES-P is in a home area of the P2P client and the information of the ES-P in a home area of the P2P client and/or other P2P client nodes that are able to provide slice data is received from a request routing system that supports P2P technology (RRS-P).

25. The method of claim 23, wherein the step of delivering the data comprises:
registering, by the P2P client, with a RRS-P as a helper node of a live channel; and
by the P2P client, obtaining corresponding slice data of the live channel as the helper node and caching the slice data locally, and delivering the data upon reception of a data request initiated by another P2P client.

26. The method of claim 25, wherein a sleep timer is set in the P2P client;
when the P2P client is idle, the sleep timer is started; and
when the sleep timer expires, the P2P client registers, with the RRS-P as a helper node of a live channel.

27. The method of claim 23, further comprising:
initiating, by the P2P client, a registration request to a RRS-P; and
receiving, by the P2P client, a unique identifier assigned by the RRS-P and configuration information generated by the RRS-P.

28. The method of claim 23, wherein, when an uplink traffic volume provided by the helper node or number of connected user is below a first preset threshold,
by the helper node, starting an adjustment timer;
initiating an adjustment request to the RRS-P when the adjustment timer expires; and
if the uplink traffic provided by the helper node or the number of connected user is equal to or larger than the set threshold and the an adjustment timer doesn't expire, the adjustment timer is stopped.
